(19) United States
(12) Patent Application Publication
(10) Pub. No.: US 2015/0345996 A1
(43) Pub. Date: Dec. 3, 2015

(54) APPARATUSES AND METHODS FOR MEASURING AN ANGLE BETWEEN A WEB OF MATERIAL AND A CONVEYANCE DIRECTION

(71) Applicant: Corning Incorporated, Corning, NY (US)

(72) Inventors: Douglas Edward Brackley, Horseheads, NY (US); Chester Hann Huei Chang, Painted Post, NY (US); Todd Benson Fleming, Elkland, PA (US); Terrence Richard Horsfall, Lexington, KY (US); David Joseph Kuhn, Prattsburgh, NY (US); Gary Edward Merz, Rochester, NY (US); Eric Lee Miller, Lawrenceville, PA (US); Ian David Tracy, Corning, NY (US)

(21) Appl. No.: 14/722,668

(22) Filed: May 27, 2015

Related U.S. Application Data
(60) Provisional application No. 62/004,446, filed on May 29, 2014.

(51) Int. Cl. G01D 5/20; C03B 17/06; C03B 35/16; B65H 23/02

(52) U.S. Cl. CPC G01D 5/20; B65H 23/0204; C03B 17/064; C03B 35/163; C03B 2225/02

(57) ABSTRACT

In one embodiment, an angle measurement device for measuring an angle between a web of material and a conveyance direction includes a mounting bracket, a shaft rotatably coupled to the mounting bracket such that the shaft is rotatable with respect to the mounting bracket, a caster portion coupled to a first end of the shaft and positioned to contact a surface of the web of material being drawn over a web conveyance pathway, where the caster portion is spaced apart from an axis of rotation of the shaft, and an angular displacement sensor coupled to the mounting bracket and positioned to detect an angular orientation of the shaft with respect to the mounting bracket, where the angular displacement sensor outputs a signal indicative of the angular orientation of the shaft with respect to the mounting bracket.

### CROSS-REFERENCE TO RELATED APPLICATIONS

This application claims the benefit of priority under 35 U.S.C. §120 of U.S. Application Ser. No. 62/004,446, filed on May 29, 2014, the content of which is relied upon and incorporated herein by reference in its entirety.

### BACKGROUND

1. Field

The present specification generally relates to apparatuses and methods for measuring an angle between a web of material and a conveyance direction.

2. Technical Background

Thin, flexible glass webs can be used in various applications, including so-called “e-paper,” color filters, photovoltaic cells, displays, OLED lighting, and touch sensors. The glass for such substrates can be quite thin, typically less than about 0.3 mm. The processing of the substrates can be performed on an individual glass sheet basis, or most efficiently, by conveying the substrate as a long glass web, which can be wound on a roll or spool. Such methods include conveying newly formed glass webs to a glass manufacturing apparatus, processing the glass web, and then winding the glass web onto a take-up roll. Alternatively, the glass web can be singulated into discrete components or sheets instead of the final winding onto a take-up roll.

One drawback to processing glass webs and winding the glass webs on a take up roll is the brittleness of the thin glass web. Specifically, mechanical contact of the glass web during handling can lead to damage, including scratches, chipping, and fracture. The problems may be exacerbated if the web is misaligned during processing and winding, resulting in the glass webs being discarded, thereby increasing manufacturing costs and reducing production yields.

Accordingly, there is a need for apparatuses and methods to determine angular misalignment as the glass webs are conveyed through the manufacturing operations.

### SUMMARY

In one embodiment, an angle measurement device for measuring an angle between a web of material and a conveyance direction includes a mounting bracket, a shaft rotatably coupled to the mounting bracket such that the shaft is rotatable with respect to the mounting bracket, a caster portion coupled to a first end of the shaft and positioned to contact a surface of the web of material being drawn over a web conveyance pathway, where the caster portion is spaced apart from an axis of rotation of the shaft, and an angular displacement sensor coupled to the mounting bracket and positioned to detect an angular orientation of the shaft with respect to the mounting bracket, where the angular displacement sensor outputs a signal indicative of the angular orientation of the shaft with respect to the mounting bracket.

In another embodiment, a method for measuring an angle between a web of material and a conveyance direction of the web of material includes directing the web of material in the conveyance direction on a web conveyance pathway, contacting a surface of the web of material with a caster portion of an angle measurement device, where the caster portion is connected to a shaft that is rotatably coupled to a mounting bracket of the angle measurement device, the caster portion is spaced apart from an axis of rotation of the shaft, and contact between the caster portion and the web of material rotates the shaft with respect to the mounting bracket, detecting an angular orientation of the shaft with respect to the mounting bracket about the axis of rotation of the shaft, and determining an angle between the web of material and the conveyance direction based on the angular orientation of the shaft with respect to the mounting bracket.

In yet another embodiment, an angle measurement device for measuring an angle between a web of material and a conveyance direction includes a mounting bracket, a shaft rotatably coupled to the mounting bracket such that the shaft is rotatable with respect to the mounting bracket, a coupling member portion coupled to a first end of the shaft, where the coupling member portion includes a hinge, a caster portion coupled to the coupling member portion and positioned to contact a surface of the web of material being drawn over a web conveyance pathway, where the caster portion is spaced apart from an axis of rotation of the shaft, the caster portion pivots with respect to the mounting bracket about an axis of rotation of the hinge, and the caster portion is rotatable about an axis of rotation perpendicular to the axis of rotation of the shaft, and an angular displacement sensor coupled to the mounting bracket and positioned to detect an angular orientation of the shaft with respect to the mounting bracket, where the angular displacement sensor outputs a signal indicative of the angular orientation of the shaft with respect to the mounting bracket.

Additional features and advantages of the embodiments will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a side view of a manufacturing apparatus having an angle measurement device for measuring an angle between a web of material and a conveyance direction according to one or more embodiments shown or described herein;

FIG. 2 schematically depicts a top view of a manufacturing apparatus having an angle measurement device for measuring an angle between a web of material and a conveyance direction according to one or more embodiments shown or described herein;

FIG. 3 schematically depicts an angle measurement device for measuring an angle between a web of material and a conveyance direction according to one or more embodiments shown or described herein;

FIG. 4 schematically depicts a top view of a manufacturing apparatus having an angle measurement device for measuring an angle between a web of material and a conveyance direction according to one or more embodiments shown or described herein;

FIG. 5 schematically depicts a perspective view of a manufacturing apparatus with multiple angle measurement devices for measuring an angle between a web of material and edge beads separated from the web of material according to one or more embodiments shown or described herein; and

FIG. 6 schematically depicts a glass production apparatus including an angle measurement device for measuring an angle between a web of material and a conveyance direction according to one or more embodiments shown or described herein.

### DETAILED DESCRIPTION

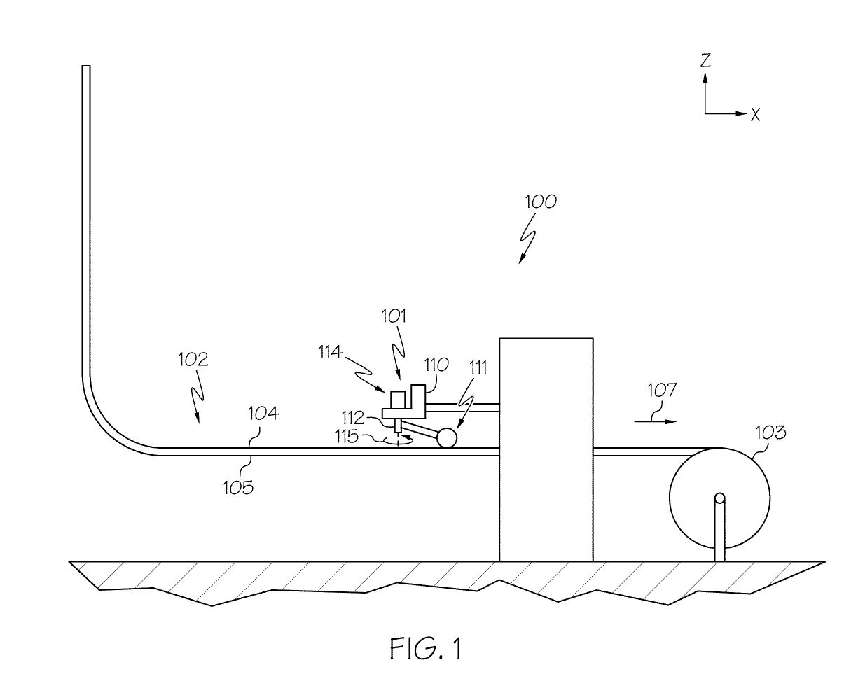

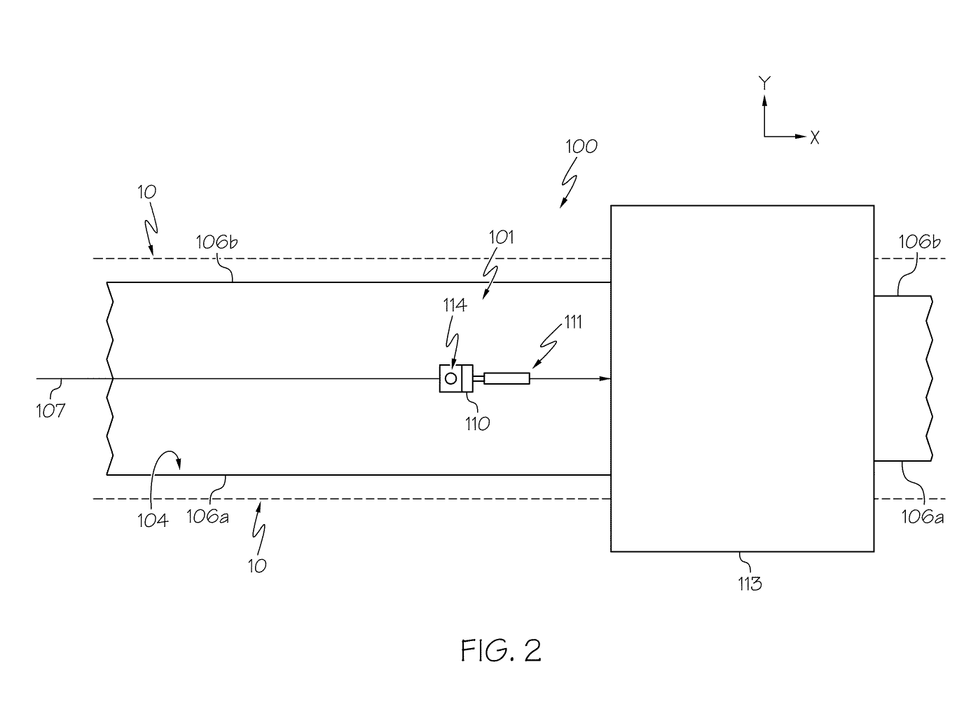

Reference will now be made in detail to embodiments of apparatuses and methods for measuring an angle between a web of material and a conveyance direction as the web of material is conveyed through various manufacturing operations. Whenever possible, the same reference numerals will be used throughout the drawings to refer to the same or like parts. FIGS. 1 and 2 schematically depict one embodiment of a web conveying apparatus with an angle measurement device for measuring an angle between a conveyance direction and a web of material, such as a flexible glass web. The angle measurement device generally includes a mounting bracket, a shaft rotatably coupled to the mounting bracket, a caster portion coupled to a first end of the shaft and positioned to contact a surface of the web of material, and an angular displacement sensor mounted to the mounting bracket. The angular displacement sensor outputs a signal indicative of the angular orientation of the shaft with respect to the mounting bracket. The web of material is generally directed on a web conveyance pathway in a conveyance direction such that the caster portion of the angle measurement device contacts a surface of the web of material. As the web of material is drawn in the conveyance direction, friction between the surface of the web of material and the caster portion may cause the caster portion, and subsequently the shaft, to rotate with respect to the mounting bracket. Specifically, the friction between the surface of the web of material and the caster portion will cause the caster portion and the shaft to rotate with respect to the mounting bracket at an angle that is indicative of an angle between the web of material and the conveyance direction. Web conveying apparatuses with angle measurement devices and methods for measuring an angle between a web of material and a conveyance direction will be described in more detail herein with specific reference to the appended drawings.

The phrase “communicatively coupled” is used herein to describe the interconnectivity of various components of the angle measurement device and means that the components are connected either through wires, optical fibers, or wirelessly such that electrical, optical, and/or electromagnetic signals may be exchanged between the components.

While glass is generally known as a brittle material, inflexible and prone to scratching, chipping and fracture, glass having a thin cross section can in fact be quite flexible. Glass in long thin sheets or webs can be wound and un-wound from rolls, much like paper or plastic film. However, even though glass can be made flexible, it retains its brittle characteristic, and can be damaged by contact.

Maintaining lateral alignment of the glass web as the glass web travels through glass manufacturing equipment may be complicated by misalignment of components of the glass manufacturing equipment. Further, instabilities, perturbations, vibrations, and transient effects that may exist in manufacturing environments or in processing and handling equipment may cause intermittent or extended misalignment of the glass web in the lateral direction to occur. In extreme cases, lateral misalignment of the glass web may lead to fracture.

For example, alignment (or misalignment) between the glass web and glass manufacturing equipment may affect the quality of the processes carried out by the glass manufacturing equipment. In particular, some glass webs are processed by continuously separating thickened edge beads from the glass web. During the bead removal process, the thickened edge beads are separated from the glass web, and the thickened edge beads are conveyed down alternate paths than the glass web. The thickened beads impart stress on the glass web at the points where the glass web is separated from the thickened edge beads. The relative angles between the glass web and the separated thickened edge beads affects the stress at the separation points, and misalignment of the glass web entering the bead separation process can increase the stress at the separation points, potentially causing web breakage. Further, misalignment between the glass web and the bead removal process may prevent the edge beads from being accurately removed from the glass web, potentially resulting in significant manufacturing losses as portions of the glass may be discarded.

The apparatuses and methods described herein provide for measuring an angle between a web of material and a conveyance direction as the web is fed through manufacturing and processing equipment. By measuring the angle between the web of material and the conveyance direction, misalignment of the web of material may be identified so that the misalignment of the web of material may be corrected.

Referring now to FIGS. 1, 2, and 3, one embodiment of a web conveying apparatus 100 that includes an angle measurement device 101 is schematically depicted. The web conveying apparatus 100 may generally include a conveying mechanism, such as take-up roll 103, and an angle measurement device 101. While specific reference is made herein to glass webs and glass manufacturing apparatuses, it should be understood that the methods and apparatuses for measuring an angle between a web of material and a conveyance direction may also be used in conjunction with other materials including, without limitation, polymeric materials, metallic materials, and the like. In the embodiments described herein, the web conveying apparatus 100 conveys a glass web 102 having a top surface 104, and a bottom surface 105 opposite the top surface 104. The glass web 102 also has opposing lateral edges 106a and 106b which are generally perpendicular to the top surface 104 and the bottom surface 105 of the glass web 102.

In the embodiment of the web conveying apparatus 100 depicted in FIGS. 1 and 2, simplified representations of a glass web 102 being conveyed with the web conveying apparatus 100 are depicted. Specifically, FIGS. 1 and 2 schematically depict a glass web 102 being transferred from an upstream manufacturing process, such as a fusion draw process, slot draw process, or the like, to a take-up roll 103. In this embodiment, the glass web 102 is initially drawn from the upstream manufacturing process in a generally vertical direction (i.e., in the +/−Z-direction of the coordinate axes depicted in FIG. 1) and redirected into a substantially horizontal plane (i.e., in a plane substantially horizontal to the plane defined by the +/−X-directions and the +/−Y-directions of the coordinate axes depicted in FIG. 2). In embodiments, the glass web may be redirected from vertical to substantially horizontal using various non-contact web routing devices such as air turns and/or non-contact dancer mechanisms, such as those described in U.S. Pat. No. 8,397,539 assigned to Corning, Inc.

While FIGS. 1 and 2 depict the introduction of the glass web 102 into the web conveying apparatus 100 from an upstream manufacturing process and taking up the glass web 102, it should be understood that other implementations of the web conveying apparatus 100 are contemplated. For example, in some embodiments, the web conveying apparatus 100 may be implemented in roll-to-roll processing of wound glass webs, wherein a formed glass web is unwound from an input spool, processed, and re-wound on a take-up spool.

In embodiments, the web conveying apparatus 100 may optionally include a conveyance mechanism which provides a tractor force to the glass web. For example, in the embodiment of the web conveying apparatus 100 depicted in FIG. 1, the web conveying apparatus 100 includes a take-up roll 103, on which the glass web 102 is collected for removal from the web conveying apparatus 100. The take-up roll 103 may generally comprise a rotating spool or spindle on which the glass web 102 may be wound. In embodiments, the take-up roll 103 may be powered or driven and the speed of rotation of the take-up roll 103 may be varied to achieve a desired rate of conveyance of the glass web 102. For example, in embodiments where the web conveying apparatus 100 is used to convey glass from an upstream forming process, such as the fusion draw process or the like, the speed of rotation of the take-up roll 103 may be varied to coincide with the rate at which the glass is drawn from the upstream forming process. While the web conveying apparatus 100 is depicted in FIG. 1 as comprising a take-up roll 103 as a conveyance mechanism which provides a tractor force to the glass web 102, it should be understood that other conveyance mechanisms are contemplated including, without limitation, powered rollers, powered pinch rollers, and the like.

In the embodiments described herein, the conveyance mechanism of the web conveying apparatus 100 is utilized to draw the glass web 102 in a conveyance direction 107 on a web conveyance pathway 10. As the glass web 102 is drawn in the conveyance direction 107, an angle between the glass web 102 and the conveyance direction 107 is measured by an angle measurement device 101.

Still referring to FIGS. 1, 2, and 3, in embodiments, the angle measurement device 101 includes a mounting bracket 110, a shaft 112 rotatably coupled to the mounting bracket 110, a caster portion 111 coupled to the shaft 112, and an angular displacement sensor 114 coupled to the mounting bracket 110 and positioned to detect an angular orientation of the shaft 112 with respect to the mounting bracket 110.

As depicted in FIGS. 1, 2, and 3, the mounting bracket 110 of the angle measurement device 101 is positioned proximate to the web conveyance pathway 10. The location of the mounting bracket 110 of the angle measurement device 101 may be fixed relative to the web conveyance pathway 10, with the mounting bracket 110 of the angle measurement device 101 cantilevered over the web conveyance pathway 10, as shown in FIG. 1.

The shaft 112 of the angle measurement device 101 is rotatably coupled to the mounting bracket 110, such that the shaft may rotate with respect to the mounting bracket 110 about an axis of rotation 115 of the shaft 112. In embodiments, the shaft 112 may be coupled to the mounting bracket 110 by the angular displacement sensor 114, as will be described in greater detail herein. Alternatively or additionally, the shaft 112 may be coupled to the mounting bracket by a bearing assembly (not depicted) so that the shaft 112 freely rotates with respect to the mounting bracket 110. The axis of rotation 115 of the shaft 112 may be generally perpendicular to the web conveyance pathway 10.

In embodiments, the angle measurement device 101 includes a trailing arm assembly 116 coupled to the shaft 112. The trailing arm assembly 116 includes a caster portion 111, an arm portion 125, and a coupling member portion 118. The arm portion 125 is coupled to the caster portion 111 and the coupling member portion 118. The coupling member portion 118 is coupled to the shaft 112. The arm portion 125 spaces the caster portion 111 apart from the axis of rotation 115 of the shaft 112, as schematically depicted in FIGS. 1, 2, and 3. By spacing the caster portion 111 of the trailing arm assembly 116 apart from the shaft 112, the space between the caster portion 111 and the shaft 112 creates a moment arm, allowing the caster portion 111 to readily rotate the shaft 112 with respect to the mounting bracket 110 about the axis of rotation 115 of the shaft 112.

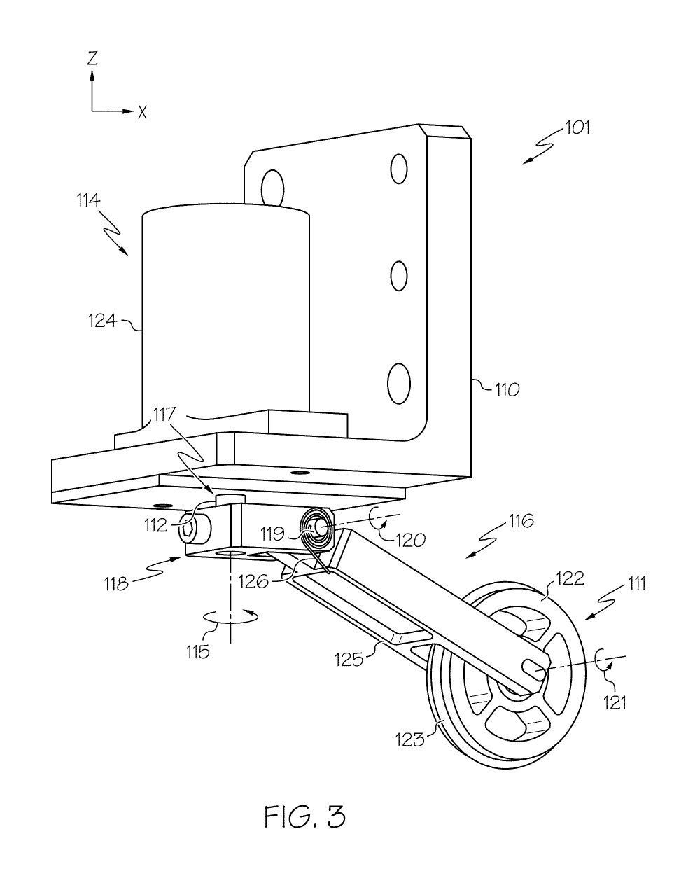

Referring to FIG. 3, the coupling member portion 118 may couple the arm portion 125, and subsequently, the caster portion 111, to the shaft 112. In some embodiments, the coupling member 118 portion fixedly attaches the arm portion 125, and subsequently, the caster portion 111, to the shaft 112, such that the caster portion 111 and arm portion 125 do not pivot with respect to the shaft 112. In other embodiments, the coupling member portion 118 of the trailing arm assembly 116 may optionally comprise a hinge 119 having an axis of rotation 120. The coupling member portion 118 may be positioned such that the axis of rotation 120 of the hinge 119 is nominally perpendicular to the web conveyance direction 107. However, it should be understood that the axis of rotation 120 of the hinge 119 may shift with respect to the web conveyance direction 107 as the glass web 102 shifts with respect to the web conveyance direction 107, as will be described in greater detail herein.

The hinge 119 of the coupling member portion 118 allows the caster portion 111 to pivot with respect to the mounting bracket 110 about the axis of rotation 120 of the hinge 119 and, in particular, allows the caster portion 111 to move with respect to the mounting bracket in the +/−Z-direction of the coordinate axis depicted on FIG. 3. Allowing the caster portion 111 to move with respect to the mounting bracket 110 in the +/−Z-direction helps the caster portion 111 remain in contact with the top surface 104 of the glass web 102 when the glass web 102 moves in the +/−Z-direction as the glass web 102 is drawn over the web conveyance pathway 10.

Still referring to FIG. 3, the caster portion 111 is coupled to the arm portion 125 of the trailing arm assembly 116. In embodiments, such as when the caster portion 111 comprises a rotating element such as a wheel or similar rotating element, the caster portion 111 may optionally have an axis of rotation 121. In these embodiments, the axis of rotation 121 of the caster portion 111 is generally perpendicular to the axis of rotation 115 of the shaft 112. The axis of rotation 121 of the caster portion 111 permits the caster portion 111 to rotate with respect to the trailing arm assembly 116. Because the caster portion 111 may be rotatable with respect to the trailing arm assembly 116 in these embodiments, reaction forces as a result of the contact between the caster portion 111 and the top surface 104 of the glass web 102 may be minimized, which in turn minimizes damage to the glass web 102.

In embodiments, the rotating element of the caster portion 111 is a wheel 122, which has an outer circumference 123. The wheel 122 of the caster portion 111 may be rotatable with respect to the trailing arm assembly 116 about the axis of rotation 121 of the caster portion 111. The outer circumference 123 of the wheel 122 of the caster portion 111 may be positioned to contact the top surface 104 of the glass web 102. As described above, because the wheel 122 of the caster portion 111 is rotatable with respect to the trailing arm assembly 116, reaction forces as a result of the contact between the top surface 104 of the glass web 102 and the outer circumference 123 of the wheel 122 of the caster portion 111 may be minimized, which in turn minimizes damage to the glass web 102.

Alternatively, the caster portion 111 may comprise a ball or sphere (not depicted) or a similar rotating element positioned to contact the top surface 104 of the glass web 102. In yet another alternative embodiment, the caster portion 111 may comprise a stationary element, such as a stylus coupled to the arm portion 125. The stylus may be positioned to contact the top surface 104 of the glass web 102. The stylus may be formed from a soft and/or flexible material so that contact between the stylus and the top surface 104 of the glass web 102 does not damage the glass web 102.

Still referring to the embodiment of the angle measurement device 101 depicted in FIG. 3, the outer circumference 123 of the wheel 122 may have a durometer hardness of less than or equal to about 50 Shore A. For example, the outer circumference 123 of the wheel 122 may be formed from materials including, but not limited to elastomers, thermoplastic polymers, nylon, and the like, which have the desired durometer hardness value. In another embodiment, the outer circumference 123 of the wheel 122 may have a durometer hardness of less than or equal to about 40 Shore A. In yet another embodiment, the outer circumference 123 of the wheel 122 may have a durometer hardness of less than or equal to about 30 Shore A. By forming the outer circumference 123 of the wheel 122 to have a relatively low durometer value, the outer circumference 123 of the wheel 122 is relatively soft so as to prevent damage to the glass web 102 as a result of contact with the outer circumference 123 of the wheel 122.

In one embodiment, the coupling member portion 118 may further comprise a biasing member 126 coupled to the hinge 119. The biasing member 126 biases the caster portion 111 and the arm portion 125 in the +Z-direction toward the mounting bracket 110, as depicted in FIG. 3. In embodiments, the biasing member 126 comprises a torsion spring. Alternatively, the biasing member may comprise a compression spring, a tension spring, or the like. The biasing member 126 may bias the caster portion 111 in the +Z-direction by rotating the caster portion 111 about the axis of rotation 120. Biasing the caster portion 111 in the +Z direction at least partially counteracts the effect of gravity on the caster portion 111 thereby reducing an apparent mass of the caster portion 111.

As used herein, the term “apparent mass” is used to describe a mass corresponding to an observed force imparted by an object as a result of gravity. For example, in embodiments where the coupling member portion 118 includes a hinge 119, a mass of the caster portion 111 and the arm portion will impart a force on the top surface 104 of the glass web 102. In embodiments of the coupling member portion 118 which further include a biasing member 126, the biasing member 126 at least partially counteracts the effect of gravity on the caster portion 111, reducing the force imparted on the top surface 104 of the glass web 102. The reduced force corresponds to a reduced apparent mass, i.e., the mass that would be expected corresponding to the observed force imparted on the top surface 104 if no biasing member were present. In embodiments, the biasing member 126 biases the arm portion 125 and the caster portion 111 in the +Z-direction such that the apparent mass of the caster portion 111 is less than the actual mass of the caster portion 111. In embodiments not including a biasing member 126, the apparent mass of the caster portion 111 is equivalent to the actual mass of the caster portion 111.

In embodiments, an apparent mass of the caster portion 111 may be less than or equal to about 20 grams. In other embodiments, an apparent mass of the caster portion may be less than or equal to about 15 grams. By limiting the apparent mass of the caster portion 111, the force imparted on the top surface 104 of the glass web in the +/−Z-direction as a result of gravity may be similarly limited, thereby reducing damage to the top surface 104 of the glass web 102.

Still referring to FIG. 3, in embodiments, the angle measurement device 101 includes an angular displacement sensor 114 coupled to the mounting bracket. The angular displacement sensor 114 is positioned to detect an angular position of the shaft 112 with respect to the mounting bracket 110 about the axis of rotation 115 of the shaft 112. In one embodiment, the shaft 112 may be rotatably coupled to a housing 124 of the angular displacement sensor 114 by a stator (not shown). By rotatably coupling the shaft 112 to the housing 124, the angular displacement sensor 114 also rotatably couples the shaft 112 to the mounting bracket 110. In embodiments, the angular displacement sensor 114 may be a rotary variable differential transformer (RVDT). Alternatively, the angular displacement sensor 114 may be a rotary variable inductive transducer (RVIT), a magnetic encoder, or any other suitable sensor known in the art for detecting a rotational position. In one embodiment the angle displacement sensor may be a Positek RVDT available from Positek Ltd., Chetlenham, UK.

In embodiments, the angular displacement sensor 114 of the angle measurement device 101 may be communicatively coupled to a control unit (not depicted) and configured to output electronic signals to the control unit indicative of the angular orientation of the shaft 112 with respect to the mounting bracket 110. The control unit may include software and/or hardware to receive the electronic signals from the angular displacement sensor 114 and determine the angular orientation of the shaft 112 with respect to the mounting bracket 110.

Turning now to FIGS. 1 and 2, in operation, the glass web 102 is initially drawn in a conveyance direction 107 over the web conveyance pathway 10 which is substantially parallel to the X-Y plane defined by the coordinate axes depicted in FIG. 2. In the embodiment shown in FIGS. 1 and 2, the glass web 102 is drawn in the conveyance direction 107 by rotation of the take-up roll 103 which draws the glass web 102 over the web conveyance pathway 10.

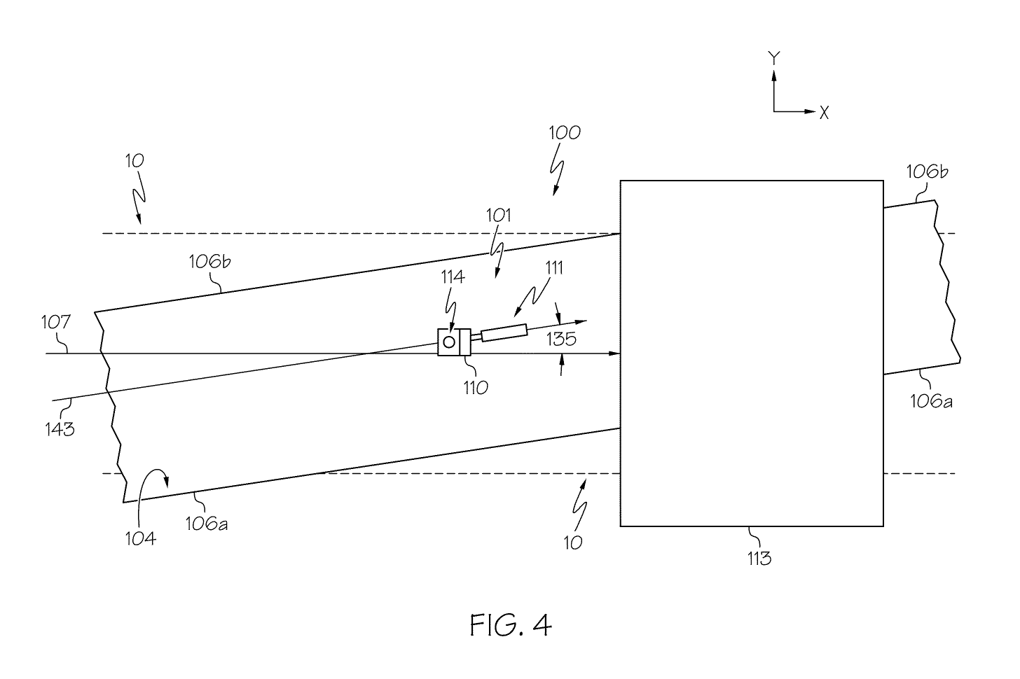

Referring to FIG. 4, as the glass web 102 is conveyed along the web conveyance pathway 10, the glass web 102 may deviate laterally such that the lateral edges 106a and 106b of the glass web 102 are no longer parallel with the conveyance direction 107, as depicted in FIG. 4, and an angle 135 is present between a centerline 143 of the glass web 102 and the conveyance direction 107. The centerline 143 of the glass web 102, as used herein, refers to the imaginary line which is parallel to the lateral edges 106a, 106b, extends in the length direction of the glass web 102 (i.e., in the +/−Y-direction of the coordinate axes depicted in FIG. 4), and evenly bisects the glass web in a width direction of the glass web 102 (i.e., in the +/−X-direction of the coordinate axes depicted in FIG. 4). As the glass web 102 is conveyed over the web conveyance pathway, the caster portion 111 of the trailing arm assembly 116 of the angle measurement device 101 tracks with the glass web 102. Specifically, friction between the caster portion 111 and the top surface 104 of the glass web 102 causes the caster portion 111 and, subsequently, the shaft 112 to rotate with respect to the mounting bracket 110. As the caster portion 111 and the shaft 112 rotate with respect to the mounting bracket 110, the angular orientation of the shaft 112 with respect to the mounting bracket 110 is indicative of an angle 135 between the centerline 143 of the glass web 102 and the conveyance direction 107. By identifying an angle 135 between the centerline 143 of the glass web 102 and the conveyance direction 107, misalignment of the glass web 102 during the manufacturing process can be identified and corrected.

In embodiments, the angular displacement sensor 114 detects the angular orientation of the shaft 112 with respect to the mounting bracket 110, and outputs an electronic signal indicating the angular orientation of the shaft 112 with respect to the mounting bracket 110. The electronic signals from the angular displacement sensor 114 may be used to adjust the position of the glass web 102 as described in co-pending U.S. patent application Ser. No. ______ (Attorney Docket No. 24922 PA), which is assigned to Corning, Inc.

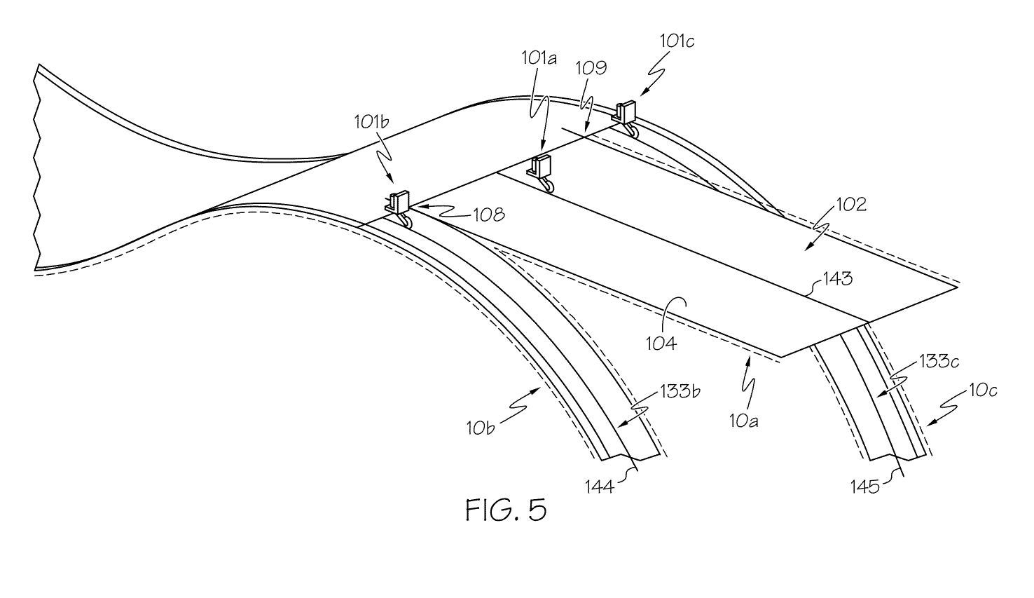

Referring now to FIG. 5, in some embodiments, multiple angle measurement devices 101a, 101b, and 101c may be used in combination. As the glass web 102 is conveyed over the web conveyance pathway 10, the glass web 102 may be conveyed into a glass processing machine, such as a bead removal machine, which removes thickened edge beads 133b and 133c formed on the glass web 102 during the formation process by laser or mechanical separation. The thickened edge beads 133b and 133c may be removed from the glass web 102 at separation points 108 and 109 respectively. The thickened edge beads 133b and 133c may then be conveyed down web conveyance pathways 10b and 10c, which are separate from a web conveyance pathway 10a of the glass web 102, to be discarded.

The thickened edge bead 133b may have a centerline 144 that evenly bisects the thickened edge bead 133b in a width direction of the thickened edge bead 133b. Similarly, the thickened edge bead 133c may have a centerline 145 that evenly bisects the thickened edge bead 133c in the width direction. As the thickened edge bead 133b is drawn over the web conveyance pathway 10b which is different than the web conveyance pathway 10a of the glass web 102, an angle between the centerline 144 of the thickened edge bead 133b and the centerline 143 of the glass web 102 may create stress at the separation point 108. Specifically, as the angle between the centerline 144 of the thickened edge bead 133b and the centerline 143 of the glass web 102 increases, the stress at the separation point 108 increases. Similarly, as the thickened edge bead 133c is drawn over the web conveyance pathway 10c, an angle between the centerline 145 of the thickened edge bead 133c and the centerline 143 of the glass web 102 may create stress at the separation point 109. As the angle between the centerline 145 of the thickened edge bead 133c and the centerline 143 of the glass web 102 increases, stress at the separation point 109 increases. High stress at the separation points 108 and 109 may lead to uncontrolled separation of the thickened edge beads 133b and 133c from the glass web 102 and fracture of the glass web 102.

To measure the angle between the centerline 144 of the thickened edge bead 133b and the centerline 143 of the glass web 102, a first angle measurement device 101a may be positioned to contact the top surface 104 of the glass web 102, and a second angle measurement device 101b may be positioned to contact a top surface of the thickened edge bead 133b. Similarly, to measure the angle between the centerline 145 of the thickened edge bead 133c and the centerline 143 of the glass web 102, the first angle measurement device 101a may be positioned to contact the top surface 104 of the glass web 102, and a third angle measurement device 101c may be positioned to contact a top surface of the thickened edge bead 133c. By measuring the angle between the centerlines 144 and 145 of the thickened edge beads 133b and 133c and the centerline 143 of the glass web 102, angular positions of the centerlines that may cause high stress at the separation points 108 and 109 may be identified and corrected.

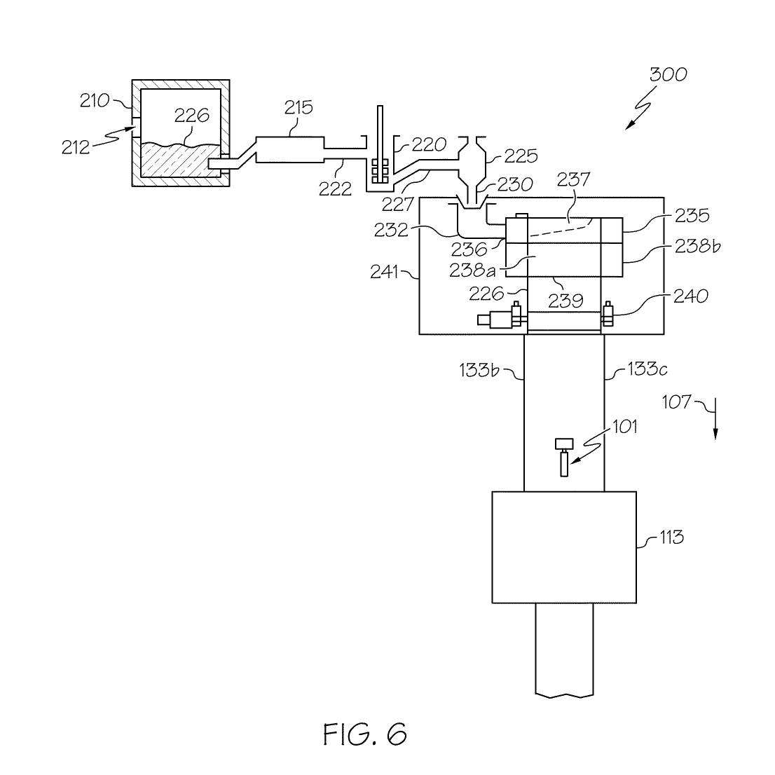

Referring now to FIG. 6, the methods and apparatuses for measuring an angle between a web of material and a conveyance direction may be used in conjunction with a glass production apparatus 200 that produces a glass web 102 from glass batch materials. The glass production apparatus 200 may include a melting vessel 210, a fining vessel 215, a mixing vessel 220, a delivery vessel 225, and a fusion draw machine (FDM) 241. Glass batch materials are introduced into the melting vessel 210 as indicated by arrow 212. The batch materials are melted to form molten glass 226. The fining vessel 215 has a high temperature processing area that receives the molten glass 226 from the melting vessel 210 and in which bubbles are removed from the molten glass 226. The fining vessel 215 is fluidly coupled to the mixing vessel 220 by a connecting tube 222. The mixing vessel 220 is, in turn, fluidly coupled to the delivery vessel 225 by a connecting tube 227.

The delivery vessel 225 supplies the molten glass 226 through a downcomer 230 into the FDM 241. The FDM 241 comprises an inlet 232, a forming vessel 235, and a pull roll assembly 240. As shown in FIG. 10, the molten glass 226 from the downcomer 230 flows into the inlet 232 which leads to the forming vessel 235. The forming vessel 235 includes an opening 236 that receives the molten glass 226 which flows into a trough 237 and then overflows and runs down two sides 238a and 238b before fusing together below a root 239. The two sides 238a and 238b of the forming vessel 235 come together such that the two overflow walls of molten glass 226 rejoin (e.g., fuse) before being drawn downward by the pull roll assembly 240 to form the glass web 102. As the glass web 102 remains in a viscous or visco-elastic state, the glass web 102 is prone to dimensional variations. To control the dimensional variation of the glass web 102, the pull roll assembly 240 “draws” the glass web 102, or applies tension to the glass web 102 as the glass web 102 continues to form from the forming vessel 235. The term “draw,” as used herein refers to moving the glass web 102 through a glass production apparatus 200 while the glass web 102 is in a viscous or visco-elastic state. The glass web 102 goes through a visco-elastic transition in a “setting zone” in which the stress and flatness are set into the glass web 102, and the glass web 102 transitions to a more elastic state.

While a fusion draw machine as described herein may be utilized to form the glass web 102, other processes and methods of forming a glass web are contemplated. For example and without limitation, the glass web 102 may also be formed using a “redraw” process or using a glass float method. In the “redraw” process, heat may be applied to a surface of a “preform” glass sheet (not depicted). As the surface of the “preform” glass sheet is heated, the “preform” glass sheet may be drawn to reduce a thickness of the “preform” glass sheet to form the glass web 102. In the glass float glass method, molten glass may be “floated” over a bed of molten metal (not depicted). As the molten glass floats over the molten metal, the molten glass spreads across the molten metal to form a glass ribbon (not depicted), where the glass ribbon has a substantially uniform thickness. The glass ribbon may then be cooled to form the glass web 102.

Referring back to FIG. 6, as the glass web 102 exits the pull roll assembly 240, the glass web 102 is in an elastic state. In one embodiment, after the glass web 102 passes through the setting zone, the glass web 102 may be conveyed into a glass processing machine 113, such as a bead removal machine, which, as noted above, removes thickened edge beads 133 formed on the glass web 102 during the formation process by laser or mechanical separation. In the case where the glass processing machine 113 is a bead removal machine, the effectiveness of the bead removal machine in removing thickened edge beads 133 from the glass web 102 directly relates to the angular alignment between the glass web 102 and the conveyance direction 107. For example, when the glass web 102 is laterally misaligned on the web conveyance pathway relative to the conveyance direction 107, an angle 135 between the centerline 143 of the glass web 102 and the conveyance direction 107 may exist as depicted in FIG. 4 (the angle 135 depicted in FIG. 4 is exaggerated for purposes of illustration). When this misalignment occurs, the edge beads may not accurately and evenly removed from the edges of glass web, potentially resulting in significant manufacturing losses as portions of the glass web are discarded for being “out of spec.” However, the lateral orientation of the glass web 102 can be measured by an angle measurement device 101, which may allow for identification of angular misalignment and subsequent correction of the angular misalignment to facilitate the accurate removal of the thickened edge beads 133 and a reduction in manufacturing losses.

Accordingly, as the glass web 102 exits the pull roll assembly 240 in the conveyance direction 107, the glass web 102 is brought into contact with the angle measurement device 101. The angle measurement device 101 determines an angle between the glass web 102 and the conveyance direction 107, as described above.

By sensing the angle between the glass web and the conveyance direction with an angle measurement device, the angle measurement device is able to sense the angular alignment of the glass web with the web conveyance pathway. Steering the glass web so that the glass web is angularly aligned with the web conveyance pathway may reduce web breakage and generally improve the alignment of the web with respect to glass processing apparatuses, such as coaters, bead removal machines, and the like. The angle measurement device may detect an angle between the glass web and the conveyance direction, or an angle between a separated thickened edge bead and the glass web which may not be detected by an edge sensor alone. Because an edge sensor only detects the position of an edge of the glass web at a single point, an edge sensor may fail to detect angular misalignment between the glass web and glass processing machine.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. An angle measurement device for measuring an angle between a web of material and a conveyance direction, the angle measurement device comprising:
a mounting bracket;
a shaft rotatably coupled to the mounting bracket such that the shaft is rotatable with respect to the mounting bracket;
a caster portion coupled to a first end of the shaft and positioned to contact a surface of the web of material being drawn over a web conveyance pathway, wherein the caster portion is spaced apart from an axis of rotation of the shaft; and
an angular displacement sensor coupled to the mounting bracket and positioned to detect an angular orientation of the shaft with respect to the mounting bracket, wherein the angular displacement sensor outputs a signal indicative of the angular orientation of the shaft with respect to the mounting bracket.

2. The angle measurement device of claim 1, wherein the caster portion is coupled to the first end of the shaft with a coupling member portion comprising a hinge such that the caster portion pivots with respect to the mounting bracket about an axis of rotation of the hinge.

3. The angle measurement device of claim 2, wherein an apparent mass of the caster portion is less than or equal to about 20 grams.

4. The angle measurement device of claim 3, further comprising a biasing member which biases the caster portion toward the mounting bracket such that the apparent mass of the caster portion is less than an actual mass of the caster portion.

5. The angle measurement device of claim 1, wherein the caster portion is rotatable about an axis of rotation generally perpendicular to the axis of rotation of the shaft.

6. The angle measurement device of claim 1, wherein the caster portion comprises a wheel, the wheel contacting the surface of the web of material being conveyed over the web conveyance pathway.

7. The angle measurement device of claim 6, wherein an outer circumference of the wheel has a durometer hardness less than or equal to about 50 Shore A.

8. The angle measurement device of claim 1, wherein the angular displacement sensor comprises a rotary variable differential transformer.

9. A method for measuring an angle between a web of material and a conveyance direction of the web of material, the method comprising:
directing the web of material in the conveyance direction on a web conveyance pathway;
contacting a surface of the web of material with a caster portion of an angle measurement device, wherein the caster portion is connected to a shaft that is rotatably coupled to a mounting bracket of the angle measurement device, the caster portion is spaced apart from an axis of rotation of the shaft, and contact between the caster portion and the web of material rotates the shaft with respect to the mounting bracket;
detecting an angular orientation of the shaft with respect to the mounting bracket about the axis of rotation of the shaft; and
determining an angle between the web of material and the conveyance direction based on the angular orientation of the shaft with respect to the mounting bracket.

10. The method of claim 9, wherein the caster portion is connected to a first end of the shaft with a coupling member portion comprising a hinge such that the caster portion pivots with respect to the mounting bracket about an axis of rotation of the hinge.

11. The method of claim 10, wherein an apparent mass of the caster portion is less than or equal to about 20 grams.

12. The method of claim 11, further comprising a biasing member which biases the caster portion toward the mounting bracket such that the apparent mass of the caster portion is less than an actual mass of the caster portion.

13. The method of claim 9, wherein the caster portion comprises a wheel that contacts the surface of the web of material being conveyed over the web conveyance pathway.

14. The method of claim 13, wherein an outer circumference of the wheel has a durometer hardness less than or equal to about 50 Shore A.

15. The method of claim 9, wherein the angular orientation of the shaft with respect to the mounting bracket is detected with a rotary variable differential transformer.

16. The method of claim 9, further comprising:
melting glass batch materials to form molten glass;
forming the molten glass into the web of material with a fusion draw machine comprising an inlet, a forming vessel, and a pull roll assembly; and
drawing the web of material through the pull roll assembly.

17. An angle measurement device for measuring an angle between a web of material and a conveyance direction, the angle measurement device comprising:
a mounting bracket;
a shaft rotatably coupled to the mounting bracket such that the shaft is rotatable with respect to the mounting bracket;
a coupling member portion coupled to a first end of the shaft, wherein the coupling member portion comprises a hinge;
a caster portion coupled to the coupling member portion and positioned to contact a surface of the web of material being drawn over a web conveyance pathway, wherein the caster portion is spaced apart from an axis of rotation of the shaft, the caster portion pivots with respect to the mounting bracket about an axis of rotation of the hinge, and the caster portion is rotatable about an axis of rotation perpendicular to the axis of rotation of the shaft; and
an angular displacement sensor coupled to the mounting bracket and positioned to detect an angular orientation of the shaft with respect to the mounting bracket, wherein the angular displacement sensor outputs a signal indicative of the angular orientation of the shaft with respect to the mounting bracket.

18. The angle measurement device of claim 17, wherein the caster portion comprises a wheel that contacts the surface of the web of material being conveyed over the web conveyance pathway.

19. The angle measurement device of claim 18, wherein an outer circumference of the wheel has a durometer hardness less than or equal to about 50 Shore A.

20. The angle measurement device of claim 17, wherein the angular displacement sensor comprises a rotary variable differential transformer.
